(19) United States
(12) Patent Application Publication
(10) Pub. No.: US 2012/0320238 A1
(43) Pub. Date: Dec. 20, 2012

(54) IMAGE PROCESSING SYSTEM, CAMERA SYSTEM AND IMAGE CAPTURE AND SYNTHESIS METHOD THEREOF

(75) Inventor: Chien-Chou Chen, New Taipei City (TW)

(73) Assignee: AMTRAN TECHNOLOGY CO. LTD, New Taipei City (TW)

(21) Appl. No.: 13/214,226

(22) Filed: Aug. 21, 2011

(30) Foreign Application Priority Data
Jun. 14, 2011 (TW) 100120732

(51) Int. Cl. H04N 5/262; H04N 5/228

(52) U.S. Cl. 348/239; 348/222.1; 348/E05.051

(57) ABSTRACT

An image processing system, a camera system and an image capture and synthesis method thereof are provided. Illumination areas of a light source are controlled according to a predetermined sequence, and a target object is photographed during the illumination period corresponding to each of the illumination areas, so as to obtain a plurality of reference images. An image processing operation is performed on the reference images to obtain a synthetic image.

### CROSS-REFERENCE TO RELATED APPLICATION

This application claims the priority benefit of Taiwan application Ser. No. 100120732, filed on Jun. 14, 2011. The entirety of the above-mentioned patent application is hereby incorporated by reference herein and made a part of this specification.

### BACKGROUND OF THE INVENTION

1. Field of the Invention

The invention generally relates to an image processing system, a camera system and an image capture and synthesis method thereof, and more particularly, to an image processing system, a camera system capable of enhancing image details and an image capture and synthesis method thereof

2. Description of Related Art

In recent years, the electronic imaging technology has been growing rapidly, and advancement in the fabrication of electronic photosensitive devices has brought a boost to many digital imaging products, such as digital cameras, digital video cameras, and PC cameras. Through these digital imaging products, dynamic or static images can be stored as digital electronic data and displayed through different types of displays (for example, computer monitors or TVs).

While capturing images by using photographic equipment on the market, the complexity of the shooting environment, the shooting target, and the background light source may cause the captured images under-exposed or over-exposed. Accordingly, the captured images are usually not very satisfactory. In order to resolve this problem, conventionally an additional light source is usually used for improving the lighting in the shooting environment (for example, a flashlight is mounted onto the photographic equipment), and the intensity of the additional light source can be adjusted when images are captured, so the photography effect can be further improved. However, this technique produces different photography effects on the foreground and background of the captured images along with the intensities of the additional light source. When the intensity of the light source is high, the background of the image would be clear but the foreground of the image would be blurry due to over-exposure. When the intensity of the light source is low, the foreground of the image would be clear but the background of the image would be blurry due to under-exposure.

### SUMMARY OF THE INVENTION

Accordingly, the invention is directed to an image processing system, a camera system and an image capture and synthesis method thereof, in which the over-exposure or under-exposure issue of the captured image can be solved, thus the details of the captured image can be effectively enhanced.

The invention provides a camera system including at least one light source, a camera unit, and an image synthesis unit. The light sources can be controlled to illuminate at least two different illumination areas. The camera unit is coupled to the light source, which controls illumination on the illumination areas according to a predetermined sequence, photographing a target object during each of at least two illumination periods corresponding to the different illumination areas of the light sources, and obtain a plurality of reference images. The image synthesis unit is coupled to the camera unit, which retrieves the reference images and performing an image processing operation on the reference images to obtain a synthetic image.

According to an embodiment of the invention, the image synthesis unit selects a base image among the reference images and subtracts another reference image from the base image to obtain the synthetic image.

According to an embodiment of the invention, the image synthesis unit adds up at least two of the reference images to obtain the synthetic image.

The invention provides an image capture and synthesis method of a camera system. The camera system includes at least one light source having at least two different illumination areas. The image capture and synthesis method includes following steps. The light sources are controlled according to a predetermined sequence setting at least two of the illumination areas. Illuminate the illuminating areas in turn according to the predetermined sequence. A target object is photographed during each period corresponding to one of the illumination areas, and obtaining a plurality of reference images. An image processing operation is performed on the reference images to obtain a synthetic image.

According to an embodiment of the invention, the image processing operation includes an image subtraction or an image addition operation.

According to an embodiment of the invention, the step of performing the image processing operation on the reference images includes selecting a base image among the reference images and subtracting another reference image from the base image.

According to an embodiment of the invention, the step of performing the image processing operation on the reference images includes adding up at least two of the reference images.

According to an embodiment of the invention, the base image is one of the reference images in which the exposure level of the target object falls within a predetermined range, or the base image is the reference image in which the target object has the highest exposure level.

The invention further provides a image processing system having an illumination control unit, a camera unit and an image synthesis unit. The illumination control unit being capable to control a plurality of light sources in a shooting location, wherein the illumination control unit can set at least two illumination areas illuminated by the light sources. The camera unit coupled to the illumination control unit, the camera unit photographing a target object during each of at least two illumination periods corresponding to the illumination areas and obtaining a plurality of reference images. The image synthesis unit coupled to the camera unit, the image synthesis unit retrieving the reference images and performing an image processing operation on the reference images to obtain a synthetic image.

As described above, in the invention, the light sources are controlled according to a predetermined sequence to light the corresponding illumination areas, and the target object is photographed during each of the illumination period corresponding to the illumination areas, so as to obtain a plurality of reference images. Besides, an image processing operation is performed on the reference images to obtain a clear synthetic image.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention,

FIG. 1 is a diagram of a camera system according to an embodiment of the invention.

FIG. 2 is a diagram of an image processing system according to an embodiment of the invention.

FIG. 3 is a flowchart of an image capture and synthesis method of a camera system according to an embodiment of the invention.

FIGS. 4A-4E are diagrams of an image capture and synthesis method of a camera system according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a diagram of a camera system according to an embodiment of the invention. Referring to FIG. 1, the camera system 100 includes a plurality of light sources 102, a camera unit 104, and an image synthesis unit 106. The camera unit 104 is coupled to the light sources 102 and the image synthesis unit 106, and the image synthesis unit 106 is coupled to a display 108. The camera system 100 may be a camera, a video camera, a TV installed with a camera, a web camera, or any other photographic equipment. The light sources 102 are remotely controlled by the camera system 100 and respectively have different illumination areas or illumination intensities for lighting up a target object and the surroundings. The light sources 102 may be respectively installed at different positions of a shooting location (for example, an indoor place) so that the light sources 102 can illuminate with respect to different depths of field.

A predetermined sequence is stored in the camera system 100 and controls the camera unit 104. The camera unit 104 controls the light sources 102, including turning on/off the light sources 102 sequentially, according to the predetermined sequence. During each of the illumination periods corresponding to different light sources 102, which illuminate different illumination areas, the camera unit 104 photographs a target object and obtains a plurality of reference images. The predetermined sequence for controlling the light sources 102 can be modified by a user according to the actual situation when operating the camera system 100. When the first time the user operates the camera system, the sequence for controlling the light sources 102 may not be determined, and the user may not know which light source should be turned on to achieve the optimal effect due to the shooting environment may have multiple light sources which can be controlled. A method is provided herein that the user can turn on each of the light sources in turn and capture images corresponding to each of the light sources. Based on these captured images, the user can determine the optimal sequence for controlling the light sources 102 as the predetermined sequence and store it in the camera unit 104. Subsequently, the camera unit 104 can control the light sources 102 according to the predetermined sequence and capture images corresponding to each of the light sources or illumination areas. That is, the predetermined sequence for controlling the light sources 102 is only required to be set at the first time the user operating the camera 100 in this method. When the camera system 100 is used for capturing images with the sequence stored, the sequence for controlling the light sources 102 does not need to be set again. According to another embodiment of the present invention, the sequence may not only control a light source each time but a combination of the light sources 102. Thus when the target object is photographed, a combination of the light sources 102 will influence the illumination areas and intensities to be photographed in the captured image.

The process of controlling the light sources 102 will be further explained in the following description. Before photographing, all the light sources 102 are controlled by the camera unit 104 and turned on, so as to determine whether the target object is within the illumination areas of the light sources 102. Then, a light source 102 close to the target object is selected to be turned on, and the unselected light sources 102 are turned off. The camera unit 104 then captures an image and determines whether the target object is sufficiently exposed according to information provided by the captured image. If the target object is under-exposed, it is determined that the target object is too far away from the light source 102. In this case, the target object is moved closer to the selected light source 102, or other light sources 102 can be selected and turned on, so the setting of light sources 102 with the optimal exposure can be found. Contrarily, If the target object is overexposed, it is determined that the target object is too close to the light sources 102. In this case, the target object is moved farther away from the light sources 102, or other light sources 102 can be selected and turned on instead of the selected light source 102, so the setting of light sources 102 with the optimal exposure can be found.

It should be noted that in the present embodiment, the illumination area is controlled by adjusting the positions of the light sources 102 or changing to different light sources 102. However, the invention is not limited thereto. In another embodiment, the illumination area may be controlled by adjusting the illumination directions of the light sources 102, and the number of the light sources 102 to be selected may also be adjusted according to the actual situation. For example, the camera system 100 can adjust the illumination area to the foreground or the background by controlling the illumination direction of a single light source 102. The camera system 100 can also adjust multiple light sources 102 and the illumination directions of them respectively.

In addition, the image synthesis unit 106 of the camera system 100 performs an image processing operation on the reference images captured by the camera unit 104 and obtains a synthetic image. The synthetic image is outputted to the display 108 and displayed. The image processing operation may be image subtraction or image addition between two or more images. For example, the image synthesis unit 106 can selects one of the reference images as a base image and subtracts one of the other reference images from the base image to obtain the synthetic image.

Aforementioned base image can be selected according to the exposure level of the target object in the reference images. For example, the camera system 100 can select one of the reference images in which the exposure level of the target object falls within a predetermined range as the base image, or the reference image in which the target object has the highest exposure level. By subtracting other reference images from the base image, objects having depths of field different from that of the target object will be blurred in the synthetic image so that the target object can be emphasized or highlighted. In another embodiment, the camera system 100 can select the reference images to perform image addition operation, and the objects in the generated synthetic image will be enhanced. It should be noted that while the camera system 100 photographs , it only requires the target object to be moved to a position with suitable exposure, and then a clear image can be obtained by synthesizing the reference images. In other words, the target object needs not to be moved to an absolutely optimal position, but any suitable location to be photographed.

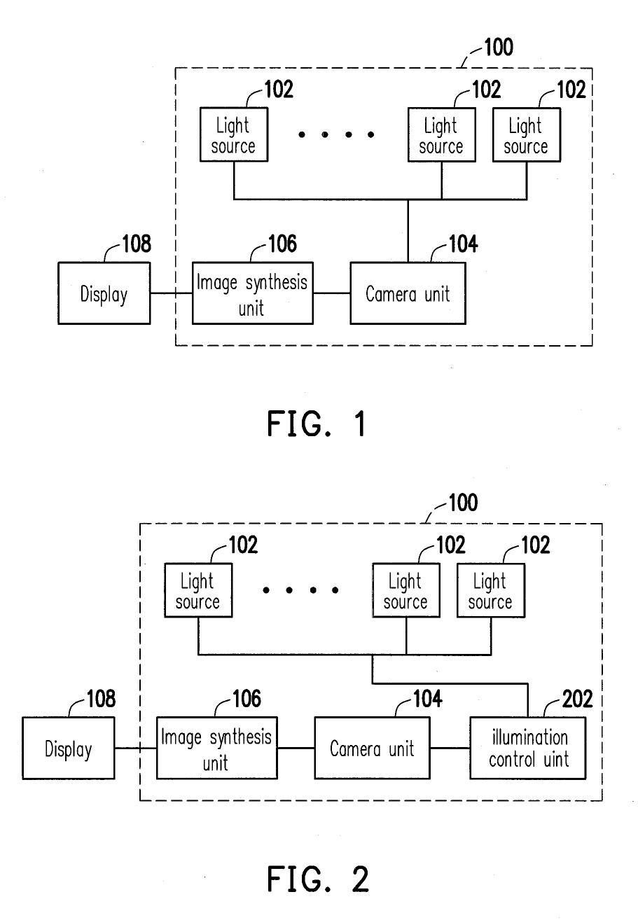

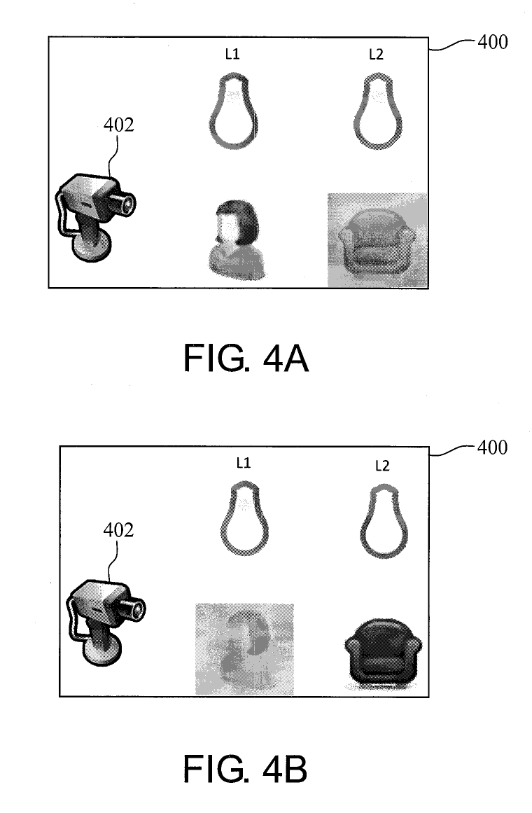

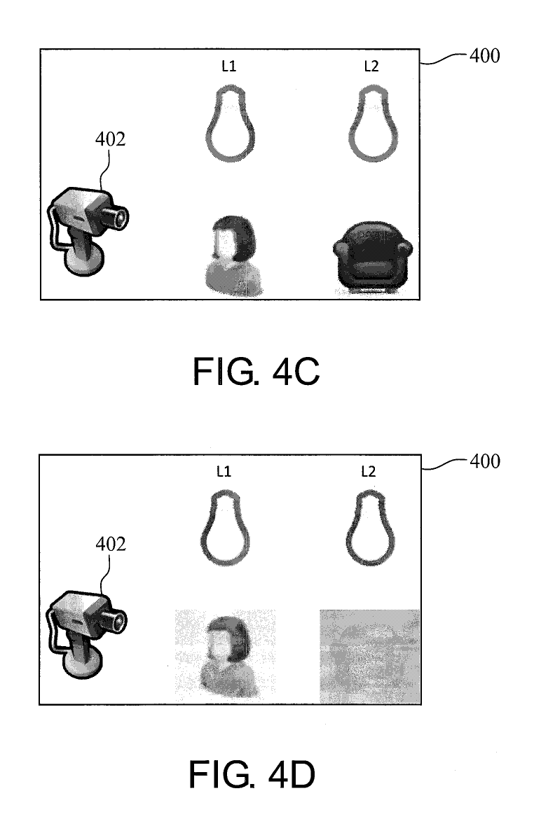

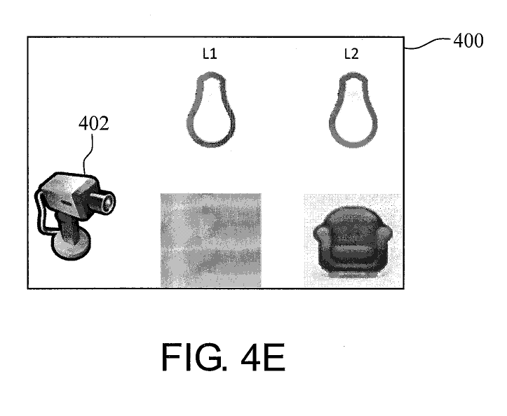

It should be noted that in another embodiment, the illumination area is controlled can be controlled by an illumination control unit. FIG. 2 is a diagram of a image processing system according to an embodiment of the invention. Referring to FIG. 1, the difference between the image processing system 200 and the camera system 100 is that the image processing system 200 further comprises an illumination control unit 202. The illumination control unit 202 is coupled to the light sources 102 and the camera unit 104. The illumination control unit 202 controls the light sources 102 in a shooting location, and set illumination areas illuminated by the light sources, and the camera unit 104 in the present embodiment is used for photographing the target object during each illumination period corresponding to the illumination areas and obtaining the reference images. The other components in the image processing system 200 have the same functions with the components in the camera system 100. The image capture and synthesis method of the image processing system 200 is similar to the camera system 100 illustrated in FIG. 4, therefore further description thereof is omitted hereafter.

As described above, the light sources are controlled and switched on/off according to a predetermined sequence. A target object is photographed during each illumination periods corresponding to the different illumination areas and a plurality of reference images are obtained. Besides, the camera system performs image processing on the reference images according to the actual requirement and output a clear synthetic image. Thereby, the unsatisfactory situation in the conventional technique that only a single image is captured and the quality of the image may be affected by improper light intensity can be avoided.

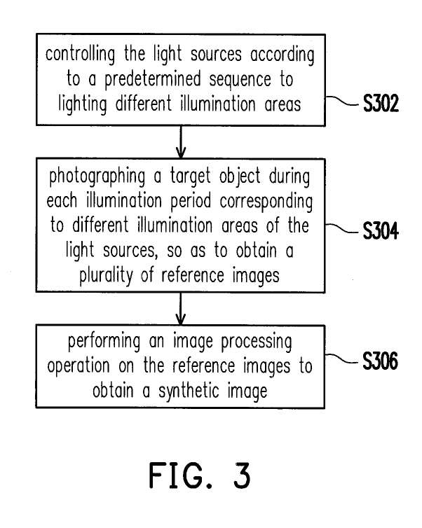

FIG. 3 is a flowchart of an image capture and synthesis method of a camera system according to an embodiment of the present invention. Referring to FIG. 3, the image capture and synthesis method of the camera system includes following steps.

First, light sources are controlled according to a predetermined sequence to lighting different illumination areas (step S302). Herein there may be one or more light sources, and the illumination areas of each light source may be controlled by adjusting the illumination directions of the light source or by switching each or a combination of the light sources on/off. Then, a target object is photographed during each of the illumination period corresponding to different illumination area of the light sources, so as to obtain a plurality of reference images (step S304). Next, an image processing operation is performed on the reference images to obtain a synthetic image (step S306). Herein the image processing operation may be an image subtraction or image addition operation. For example, a base image is selected from the reference images, and another reference image is subtracted from the base image to obtain the synthetic image. Or, another reference image may be added up to obtain the synthetic image.

FIGS. 4A-4E are diagrams of an image capture and synthesis method of a camera system according to an embodiment of the present invention. An example of the image capture and synthesis method is given below that the camera system is assumed to control two light sources in the shooting location. In the embodiment illustrated in FIGS. 4A-4E, the camera system 400 includes two light sources L1 and L2, a camera unit 402, and an image synthesis unit (not shown). The objects to be photographed in the example include a person and a chair, where the person is the target object (the person is in foreground to the camera unit 402, and the chair is in background). As described in foregoing embodiments, the light sources are firstly controlled according to a predetermined sequence and illuminate different illumination areas. In FIG. 4A, the light source L1, whose illumination area is close to the foreground, is turned on and the light source L2, whose illumination area is close to the background, is turned off. Thus, the person has a sufficient exposure, while the chair has a lower exposure. Accordingly, in the reference images captured by the camera unit 402 the image of the person is clearer than the image of the chair (i.e., the foreground is clear while the background is blur). Similarly, when the light source L2 is turned on and the light source L1 is turned off (as shown in FIG. 4B), the chair has sufficient exposure, while the person has a lower exposure. Accordingly, in the reference images captured by the camera unit 402, the image of the chair is clearer than that of the person (i.e., the background is clear, while the foreground is blurry).

Thereafter, an image processing operation is performed on the two reference images captured in FIG. 4A and FIG. 4B by the image synthesis unit, so as to obtain a synthetic image. Herein if the image synthesis unit performs an image addition operation on the reference images captured in FIG. 4A and FIG. 4B, the obtained synthetic image will be as shown in FIG. 4C, in which the image details of the person and the chair are more clear than the reference images (i.e., details of objects in both foreground and background are enhanced and a finer image is presented).

If the image synthesis unit performs an image subtraction operation on the reference images captured in FIG. 4A and FIG. 4B, wherein the reference image captured in FIG. 4A is selected as the base image and the image captured in FIG. 4B is subtracted from the base image, the obtained synthetic image will be as shown in FIG. 4D, in which the image details of the person (i.e., the foreground image) are slightly blurrier than the image details of the person in FIG. 4A, while the image details of the chair (i.e., the background image) are much blurrier than the image details of the chair in FIG. 4A. Thus, the image of the person in the synthetic image is emphasized in contrast.

Similarly if the image synthesis unit performs another image subtraction on the reference images captured in FIG. 4A and FIG. 4B, wherein the reference image captured in FIG. 4B is selected as the base image and the image captured in FIG. 4A is subtracted from the base image , the obtained synthetic image will be as shown in FIG. 4E, in which the image details of the chair (i.e., the background image) are slightly blurrier than the image details of the person in FIG. 4B, and the image details of the person (i.e., the foreground image) are much blurrier than the image details of the chair in FIG. 4B. Thus, the image of the chair in the synthetic image is emphasized in contrast.

As described above, a user can choose an appropriate image synthesis method according to the actual situation in order to obtain the synthetic image. For example, when the embodiment described above is applied to a video conference system and the user does not want his/her surroundings to be seen by other parties, the image processing method illustrated in FIG. 4D can be adopted to blur the background image without affecting the image of the user.

In summary, the present invention discloses a system and method for controlling light sources according to a predetermined sequence in order to illuminate different illumination areas. A target object is photographed during each of the illumination periods corresponding to different illumination areas of the light sources to obtain a plurality of reference images. Besides, an image processing system performs an image processing operation on the reference images to enhance image details of the target object and blur the background or to enhance the details of the entire image to obtain a clear image.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A camera system, comprising:
at least one light source, can be controlled to illuminate at least two different illumination areas;
a camera unit, coupled to the light source, for controlling illumination on the illumination areas according to a predetermined sequence, photographing a target object during each of at least two illumination period corresponding to the different illumination areas of the light sources, and obtain a plurality of reference images; and
an image synthesis unit, coupled to the camera unit, for retrieving the reference images and performing an image processing operation on the reference images to obtain a synthetic image.

2. The camera system according to claim 1, wherein the image processing operation comprises an image subtraction and an image addition.

3. The camera system according to claim 2, wherein the image synthesis unit selects a base image among the reference images and subtracts the other reference images from the base image to obtain the synthetic image.

4. The camera system according to claim 3, wherein the base image is one of the reference images in which exposures of the target object fall within a predetermined range or the reference image in which the target object has the highest exposure.

5. The camera system according to claim 2, wherein the image synthesis unit adds up at least two of the reference images to obtain the synthetic image.

6. The camera system according to claim 1, wherein the illumination areas are determined by the location of the light sources or the illumination directions of the light sources.

7. The camera system according to claim 1, wherein the illumination areas are changed by turning on/off the light sources according to the predetermined sequence.

8. An image capture and synthesis method of a camera system, wherein the camera system comprises at least one light source having at least two different illumination areas, the image capture and synthesis method comprising:
controlling the light sources according to a predetermined sequence setting at least two of the illumination areas;
illuminating the illuminating areas in turn according to the predetermined sequence, photographing a target object during each illumination period corresponding to one of the illumination areas, and obtaining a plurality of reference images; and
performing an image processing operation on the reference images to obtain a synthetic image.

9. The image capture and synthesis method according to claim 8, wherein the image processing operation comprises an image subtraction and an image addition.

10. The image capture and synthesis method according to claim 9, wherein the step of performing the image processing operation on the reference images comprises:
selecting a base image among the reference images; and
subtracting the other reference images from the base image.

11. The image capture and synthesis method according to claim 10, wherein the base image is one of the reference images in which exposure level of the target object falls within a predetermined range or the base image is the reference image in which the target object has the highest exposure level.

12. The image capture and synthesis method according to claim 9, wherein the step of performing the image processing operation on the reference images comprises adding up at least two of the reference images.

13. The camera system according to claim 8, wherein the illumination areas are determined by the location of the light sources or the illumination directions of the light sources.

14. An image processing system, comprising:
an illumination control unit being capable to control a plurality of light sources in a shooting location, wherein the illumination control unit can set at least two illumination areas illuminated by the light sources;
a camera unit coupled to the illumination control unit, the camera unit photographing a target object during each of at least two illumination periods corresponding to the illumination areas and obtaining a plurality of reference images; and
an image synthesis unit coupled to the camera unit, the image synthesis unit retrieving the reference images and performing an image processing operation on the reference images to obtain a synthetic image.

15. The image processing system according to claim 14, wherein the image processing operation comprises an image subtraction and an image addition.

16. The image processing system according to claim 15, wherein the image synthesis unit selects a base image among the reference images and subtracts the other reference images from the base image to obtain the synthetic image.

17. The image processing system according to claim 16, wherein the base image is one of the reference images in which exposures of the target object fall within a predetermined range or the reference image in which the target object has the highest exposure.

18. The image processing system according to claim 15, wherein the image synthesis unit adds up at least two of the reference images to obtain the synthetic image.

19. The camera system according to claim 14, wherein the illumination areas are determined by the location of the light sources or the illumination directions of the light sources.

20. The camera system according to claim 14, wherein the illumination control unit changes the illumination areas by turning on/off the light sources according to the predetermined sequence.
